(19) United States
(12) Patent Application Publication
(10) Pub. No.: US 2009/0241935 A1
(43) Pub. Date: Oct. 1, 2009

(54) GAS COOKING APPLIANCE

(76) Inventors: ATHIR JAAZ, Auckland (NZ); SIMON WOODS, Dunedin (NZ); MANJUNATH SHASTRI, Dunedin (NZ); SHANE DOWD, Dunedin (NZ); PHILIP CAUTY, Auckland (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/410,730

(22) Filed: Mar. 25, 2009

Related U.S. Application Data
(60) Provisional application No. 61/039,510, filed on Mar. 26, 2008.

(51) Int. Cl. F24C 3/00; G05D 7/00

(52) U.S. Cl. 126/39 E; 700/282

(57) ABSTRACT

A gas cook top includes a plurality of gas burners arranged on a cook top surface to accommodate a variety of cooking vessels. Each burner is associated with a valve for varying the flow of fuel gas from a supply to the burner, so that the heat output of the burner can be varied in use. The cook top includes a controller operationally coupled to an actuator associated with each valve for varying the position of each valve. The controller is configured to receive an input from a user via a user interface and operate the actuator to move a valve to a desired position along a predetermined path, wherein the path may not be the shortest distance between the current position and the desired position of the valve.

### CROSS-REFERENCE AND INCORPORATION BY REFERENCE

This application claims the domestic priority of U.S. Provisional Application Ser. No. 61/039,510, filed on Mar. 26, 2008, and entitled “A Gas Cooking Appliance”. U.S. Provisional Application Ser. No. 61/039,540 is hereby incorporated by reference in its entirety.

### FIELD OF THE INVENTION

The present invention relates to gas burners generally and more particularly to gas burners of a type suitable for use with gas cookers or cook tops.

### BACKGROUND TO THE INVENTION

There are a number of known ways to provide heat to a cook top for cooking. One preferred method uses a plurality of gas burners which burn a fuel gas in order to heat cooking vessels.

The gas burners are commonly of a burner ring form. A plurality of burner rings are usually located on a cook top surface, which typically include a trivet or stand for supporting a cooking vessel at an appropriate height above each burner ring. The heat output from the burners is controlled by varying the flow rate of fuel gas supplied to the burner ring and combusted. Typically, the supply of fuel gas is regulated by a valve associated with each burner ring. A preferred form of burner is described in WO 06/006882 which is incorporated herein by reference.

Further, it is desirable that a user of a cook top has as much control over the heat output of the burner as possible. In particular it is especially desirable that fine levels of adjustment and control are available to a user at the lower end of the heat output range of the burner. Such fine control is necessary for the preparation of particular types of cuisine. It is also desirable that the burners of a cook top have the widest range of heat output possible. This may be referred to as having a high turn-down ratio. Burners with high turn-down ratios may be suitable for cooking a wide variety of cuisine. It is also preferable that the burners of a gas cook top are capable of providing repeatable levels of heat output for each power setting.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved gas cooking appliance which goes some way to alleviating the above problems or at least provide the public with a useful choice.

### SUMMARY OF THE INVENTION

In one aspect, the present invention broadly consists in a cook top comprising:
a burner,
a valve operated by an actuator to vary the flow of fuel gas from a supply to said burner, wherein said valve is progressively opened by moving in one of a first direction and a second direction, and said valve is progressively closed by moving in the other of said first and said second direction,
a user interface configured to receive a user input indicative of a desired burner setting from a user,
a controller operationally coupled to said actuator and to said user interface, and configured to:
   determine a desired position of said valve based on said user input,
   cause said actuator to move said valve to said desired position by:
      if said desired position is in said first direction from the current position of said valve, moving said valve to said desired position, or
   if said desired position is in said second direction from the current position of said valve, moving said valve in said second direction to a position past said desired position and then moving said valve to said desired position.

Preferably the step of moving said valve to said desired position includes a terminal movement immediately prior to said valve arriving at said desired position, and
said terminal movement is always in said first direction.

Preferably said desired position is in said first direction from the current position of said valve, said step of moving said valve to said desired position includes first moving said valve in said second direction a predetermined amount and then moving said valve in said first direction to said desired position.

Preferably said first direction closes said valve.

Preferably said first direction opens said valve.

In another aspect, the present invention broadly consists in a cook top comprising:
a burner,
a valve operated by an actuator to vary the flow of fuel gas from a supply to said burner,
a user interface configured to receive a user input indicative of a desired burner setting from a user,
a controller operationally coupled to said actuator, and said user interface and configured to:
   determine a desired position of said valve based on said user input,
   cause said actuator to move said valve from an initial position to said desired position such that said valve arrives, in the terminal portion of movement, at said desired position traveling in the same direction regardless of the direction said desired position is from said initial position.

Preferably said direction of arrival closes said valve.

Preferably said direction of arrival is not the same for every desired position within the range associated with burner settings.

In another aspect, the present invention broadly consists in a valve control apparatus comprising;
an actuator coupled to said valve to vary the position of said valve,
said valve being progressively opened by moving in one of a first direction and a second direction, and progressively closed by moving in the other of said first and said second direction,
a controller operationally coupled to said actuator and configured to receive a signal to move said valve, and configured to:
   determine a desired position of said valve based on said signal,
   cause said actuator to move said valve to said desired position by:
      if said desired position is in said first direction from the current position of said valve, moving said valve to said desired position, or
      if said desired position is in said second direction from the current position of said valve, moving said valve in said second direction to a position past said desired position and then moving said valve to said desired position.

Preferably the step of moving said valve to said desired position includes a terminal movement immediately prior to said valve arriving at said desired position, and
said terminal movement is always in said first direction.

Preferably when said desired position is in said first direction from the current position of said valve, said step of moving said valve to said desired position includes first moving said valve in said second direction a predetermined amount, and then moving said valve in said first direction to said desired position.

In another aspect, the present invention broadly consists in a valve control apparatus comprising:
an actuator to vary the position of said valve,
a controller operationally coupled to said actuator and configured to receive a signal to move said valve, and configured to:
   determine a desired position of said valve based on said signal,
   cause said actuator to move said valve from an initial position to said desired position such that said valve arrives, in the terminal portion of movement, at said desired position traveling in the same direction regardless of the direction said desired position is from said initial position.

In another aspect, the present invention broadly consists in a method of controlling a valve comprising:
moving said valve from an initial position to a desired position, such that said valve arrives, in the terminal portion of movement, at said desired position traveling in the same direction) regardless of the direction said desired position is from said initial position.

Preferably, the direction in which said valve arrives at said desired position, is the direction that closes said valve.

In another aspect, the present invention broadly consists in a method of controlling a valve for delivering fuel gas to a burner comprising:
receiving a signal indicative of a desired burner setting, and determining a desired position of said valve based on said signal,
moving said valve from an initial position to said desired position such that said valve arrives, in the terminal portion of movement, at said desired position traveling in the same direction, regardless of the direction said desired position is from said initial position.

In another aspect, the present invention broadly consists in a method of controlling a valve for delivering fuel gas to a burner comprising:
receiving a signal indicative of a desired burner setting, and determining a desired position of said valve based on said signal,
if said desired position is in a first direction from the current position of said valve, moving said valve to said desired position, or
if said desired position is in a second direction from the current position of said valve, moving said valve in said second direction to a position past said desired position and then moving said valve to said desired position.

Preferably when said desired position is in said first direction from the current position of said valve, said step of moving said valve to said desired position includes first moving said valve in said second direction a predetermined amount, and then moving said valve in said first direction to said desired position.

Preferably the direction in which said valve arrives at said desired position, is the direction that closes said valve.

In another aspect, the present invention broadly consists in a cook top comprising:
a burner,
a valve operated by an actuator to vary the flow of fuel gas from a supply to said burner,
a user interface configured to receive a user input indicative of a desired burner setting from a user,
a controller operationally coupled to said actuator and said user interface, and configured to:
   determine a new desired position of said valve based on said user input,
   cause said actuator to move said valve to said new desired position by;
      if said new desired position is in the same direction as the last direction of movement of said valve as it arrived at the previous desired position; moving said valve a predetermined amount in the opposite direction to said last direction, and then moving said valve in said last direction to said new desired position, or if said new desired position is not in the same direction as said last direction, moving said valve to said new desired position.

Preferably said valve is closed by moving in said last direction.

In another aspect, the present invention broadly consists in a cook top comprising:
a burner,
a valve operated by an actuator to vary the flow of fuel gas from a supply to said burner,
a user interface configured to receive a user input indicative of a desired burner setting from a user,
a controller operationally coupled to said actuator and said user interface, and configured to:
   determine a desired position of said valve based on said user input,
   cause said actuator to move said valve from an initial position to said desired position such that the first movement of said valve is in the opposite direction as the last direction of movement of said valve as it arrived at the initial position,
   store the direction in which the valve arrived at said desired position.

In another aspect, the present invention broadly consists in a valve control apparatus comprising:
an actuator coupled to said valve to vary the position of said valve,
a controller operationally coupled to said actuator and configured to receive a signal to move said valve, and configured to:
   determine a desired position of said valve based on said signal,
   cause said actuator to move said valve to said desired position by:
      if said desired position is in the same direction as the last direction of movement of said valve as it arrived at the current position; moving said valve in a first direction a predetermined amount and then moving said valve in a second direction to said desired position, or
         if said desired position is not in the same direction as said last direction, moving said valve to said desired position, store the direction in which the valve arrived at said desired position.

In another aspect, the present invention broadly consists in a method of controlling a valve comprising:
moving said valve from an initial position to a desired position such that the first movement of said valve is in the opposite direction as the last direction of movement of said valve as it arrived at said initial position.

Preferably said method further comprises:
receiving a signal to move said valve, and determining a desired position of said valve based on said signal.

In another aspect, the present invention broadly consists in a method of controlling a valve comprising:
receiving a signal to move said valve, and determining a desired position of said valve based on said signal,
if said desired position is in the same direction as the last direction of movement of said valve as it arrived at the current position; moving said valve in a first direction a predetermined amount and then moving said valve in a second direction to said desired position, or
if said desired position is not in the same direction as said last direction, moving said valve to said desired position.

Preferably said valve delivers fuel gas to a burner and said signal is indicative of a desired burner setting.

Preferably said burner is a cook top burner and said signal is received from a user interface.

In another aspect, the present invention broadly consists in a cook top comprising:
a burner,
a valve operated by an actuator to vary the flow of fuel gas from a supply to said burner,
a user interface configured to receive a user input indicative of a desired burner setting,
a controller operationally coupled to said actuator and to said user interface, and configured to: receive a signal from said interface,
   determine a desired valve position, wherein said determination utilizes a predetermined relationship between said signal received and said desired valve position,
   cause said actuator to move said valve to said desired position.

Preferably said actuator is a stepper motor and said step of determining said desired position includes calculating the number of steps from a current position to said desired position according to said relationship.

Preferably said actuator is a stepper motor and said step of determining said desired position comprises looking up the number of steps from a current position to said desired position in a look up table.

Preferably said predetermined relationship depends on the type of fuel gas.

Preferably said cook top includes a plurality of burners of at least two different variations or type, and
said cook top includes a valve for each said burner, and
each said controller utilizes a different said predetermined relationship for each said different variations or type of burner.

Preferably said predetermined relationship is biased such that a user input indicative of a given change in desired burner setting at a lower end of the range, results in less valve adjustment than a user input indicative of a given change in desired burner setting at a higher end of the range.

Preferably said predetermined relationship is biased such that a user input indicative of a given change in desired burner setting at a lower end of the range, results in greater valve adjustment than a user input indicative of a given change in desired burner setting at a higher end of the range.

In another aspect, the present invention broadly consists in a method of controlling a valve comprising:
receiving a signal,
determine a desired valve position, wherein said determination utilizes a predetermined relationship between said signal received and said desired valve position,
causing an actuator to move said valve to said desired position.

Preferably said actuator is a stepper motor and said step of determining said desired valve position includes calculating the number of steps from a current position to said desired position according to said relationship.

Preferably said actuator is a stepper motor and said step of determining said desired position comprises looking up the number of steps from a current position to said desired position in a look up table.

Preferably said predetermined relationship is biased such that a signal indicative of a given change in setting at a lower end of a range, results in less valve adjustment than a signal indicative of a given change in setting at a higher end of a range.

Preferably said predetermined relationship is biased such that a signal indicative of a given change in setting at a lower end of a range, results in greater valve adjustment than a signal indicative of a given change in setting at a higher end of a range.

In another aspect, the present invention broadly consists in a cook top comprising:
a burner,
a user interface configured to receive a user input indicative of a desired burner setting,
a valve having a fully closed position and operated by an actuator to vary the flow of fuel gas from a supply to said burner,
a controller operationally coupled to said actuator and having two modes, wherein when in a first mode: said controller opens said valve,
   ignites said burner and detects the presence of a flame,
   while maintaining detection of the presence or absence of said flame, progressively closes said valve until said flame is no longer detected, and
   records the distance between said fully closed position of said valve and the last position of said valve when said flame was detected, as a reference offset, and
when in said second mode:
   said controller operates said burner according to said user input.

Preferably said valve position when said flame was last detected is used as the valve position corresponding to the lowest setting of said burner.

Preferably said cook top includes a plurality of burners and said controller records a reference offset for each said burner.

Preferably said controller looks up a look up table to determine how to move said valve to get from a current position to a desired position based on said input.

Preferably said look up table includes the distance from every burner setting to every other burner setting, and
said table records said reference offset for each burner as the distance from said fully closed position to a lowest burner setting.

Preferably said look up table includes the distance from each burner setting to the next lower burner setting, and
said table records said reference offset for each burner as the distance from said fully closed position to a lowest burner setting.

Preferably said actuator is a stepper motor, and said lookup table stores a value for each burner setting that is the number of steps that that setting is above the next lowest setting, and
said table records said reference offset value for the lowest burner setting.

Preferably said actuator is a stepper motor, and the number of steps from said fully closed position to the position corresponding to each burner setting is the sum of said reference offset and all the lookup table values from the lowest setting to each burner setting.

Preferably said controller stores the current distance from said fully closed position for each valve.

In another aspect, the present invention broadly consists in a method of operating a burner comprising:
opening a valve having a fully closed position to deliver a fuel gas to said burner,
igniting said burner and detecting a flame,
while continuing to detect the presence or absence of said flame, progressively closing said valve until said flame is no longer detected, and
recording the distance between said fully closed position of said valve and the last position of said valve when said flame was detected, as a reference offset.

In another aspect, the present invention broadly consists in a method of operating a burner comprising:
opening a fuel gas valve to supply fuel gas to a burner,
igniting said burner and detecting the presence of a flame,
while maintaining the detection of the presence or absence of said flame, progressively closing said valve until said flame is no longer detected, and
recording the position of said valve at the last point that said flame was detected as a reference offset.

In another aspect, the present invention broadly consists in a method of operating a burner comprising:
receiving a signal indicative of a desired burner setting,
looking up a look tip table to determine how to move said valve to get from a current position to a desired position based on said signal,
wherein said step of determining includes summing all the data in said table for each position between an off position and said desired position.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said pairs, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only. In particular, the invention has been described predominantly with reference to a single burner and valve in a cook top. It will be appreciated that this is for convenience, and that cook tops are usually equipped with multiple burners, and may even include heating elements of different types.

### BRIEF DESCRIPTION OF THE DRAWINGS

Preferred embodiments of the invention will be described by way of example only and with reference to the drawings, in which:

FIG. 1 is a schematic drawing of a cook top with controller respective burners and supply valves.

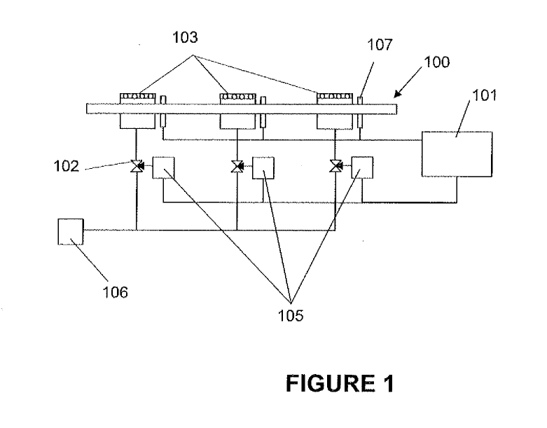

FIG. 2 is a flow chart diagram illustrating a preferred calibration method.

### DETAILED DESCRIPTION OF PREFERRED EMBODIMENTS

Typically modern cook tops include a plurality of burners to accommodate multiple cooking operations simultaneously and/or provide different burner options. In one preferred form of the invention, the cook top 100 includes a controller 101 operationally coupled to a user interface and an actuator 105 associated with each valve 102 for varying the supply of fuel gas (from gas supply 106) to each burner 103 independently.

The user interface may take many forms such as a simple rotating control knob, a translating lever, or other user controls such as touch screens, buttons or touch controls. The user interface preferably includes a form of visual feedback so that the user can easily ascertain the current burner setting. For example, a number of LED's could be arranged in the form of a bar graph (in a linear or non-linear shape) and be progressively lit and un-lit as the burner setting increases or decreases respectively.

Preferably each burner 103 is independently controlled and the user interface provides independent visual feedback for each burner setting. The controller 101 is preferably a micro processor and may be capable of driving each actuator 105 directly, or may utilize an amplification or motor driver circuit to control the actuators.

The gas supply valve 102 of each burner is coupled to a stepper motor 105 via a reduction gear box. An example of a suitable type of stepper motor is a 12V stepper motor with 48 steps per revolution. The step resolution of the stepper motor in combination with the reduction gear box gives the angular resolution with which the rotating gas valve is controlled. It will be appreciated that the required resolution will depend on the characteristics of the valve as well as the desired resolution of control over the fuel gas flow rate, which in turn dictates the actual burner heat output.

It has been found for example that a resolution of approximately 0.5° is appropriate for a valve of the type typically used in a domestic cook top with typical supply pressure and gas jet sizes. For example, 48 steps and a reduction of approximately 1:13 through the gearbox.

In use, a user manipulates the user control according to a desired burner setting. The controller 101 receives a signal from the user interface indicative of the desired burner setting and causes the actuator 105 to move the respective valve to the desired position. For positional control to be accurate, the motor must stay synchronized. i.e., when a phase is energised the motor must rotate to the new position, in order to make sure that the cook top controller does not loose track of the current position of the valve. Alternatively, the controller may receive a signal from a position sensor such as a rotary encoder in order to track the valve movement. To assist the motor staying synchronized at start-up and when changing direction, the current phase may be pre-energised before moving.

When the valve 102 is moved by the actuator 105 from a stationary position, the torque required to move the valve in each direction may differ due to the characteristics of the valve, gearbox and drivetrain. For example, if the last direction of movement was clockwise, and the valve is moved in a clockwise direction from stationary, the initial resistance of the valve may be higher. However, if the last direction of movement was clockwise, and the valve is moved in an anti-clockwise direction from stationary, the initial resistance of the valve may be lower, due to the slop or back-lash in the valve and drivetrain.

The worst case scenario of the stepper motor driving the gas valve is when the valve is stationary and the stepper motor begins to move the valve in the same direction as the last movement of the valve. Under these conditions the torque requirement of the motor is greatest and the potential for the motor to stall is highest.

In order to reduce the likelihood that the motor may stall causing the controller to lose track of the current position, the controller rotates the actuator motor backwards a pre-determined number of steps before rotating in the same direction as the previous movement.

Traveling in the reverse direction initially, presents a minimum load to the motor because of the slop or backlash in the drivetrain. When the motor shaft rotates back to the original position and picks up the full load it does so with some momentum, reducing the probability of losing synchronization between the actual position and position the controller is expecting. Preferably the number of steps the controller moves the valve backwards initially, corresponds approximately with the amount of slop in the drivetrain, and/or allows the motor to build rotational momentum. For example, approximately 2-3 degrees is typical for typical valve designs. The controller software may drive the valve using a number of suitable methods such as a wave or full step drive according to the required motor torque. Alternatively, a hybrid drive method such as half-step, or inverted halt-step, can be used.

To further assist the valve motor in staying synchronised at startup, the phase energisation time at startup may be increased from it's normal operating period. Longer phase times tend to produce more torque, but rotate, the shaft more slowly. For example, when the motor starts moving from a stationary position each phase is energised for 8 ms, then once the valve is turning, the energisation time may be lowered to 3 ms. It will be appreciated that the foregoing valve control technique can be utilized alone or in combination with any one or more of the following described valve control techniques.

Due to the slop or backlash in the drivetrain, the positional accuracy of the valve corresponding to a particular desired burner setting (and gas flow) may also be compromised. In order to improve the positional accuracy and the repeatability of each valve position corresponding to a desired burner setting, the controller is configured to actuate the valve such that it always approaches the desired valve position from the same direction. ‘r’ his method ensures that the backlash in the drivetrain is treated consistently, reducing positional errors, and is therefore more repeatable. Preferrably, the predetermined amount of travel should be greater than the sum of the possible backlashes in the valve, drivetrain, and gearbox. The authors have found that the combined backlash can be higher than 30°, for some typical types of valve/gearbox combinations.

For example, if the new desired position of the valve lies in the counter clockwise direction from the current position, then the controller causes the actuator to move the valve to the desired position such that the valve arrives (at least in the terminal portion of movement) at the desired position traveling counter clockwise. However, if the new desired position of the valve lies in the clockwise direction from the current position, then the controller causes the actuator to move the valve past the desired position by a pre-determined amount, and then moves to the desired position such that the valve arrives traveling counter clockwise (at least in the terminal portion of movement).

The positional accuracy and repeatability is improved by insuring that the terminal portion of movement as the valve arrives at a new position, is always in the same direction. Preferably the direction of the terminal portion of movement is the direction that closes the gas valve. Accordingly the lowest burner setting is approached by closing the valve (i.e. turning the burner down). Similarly, the highest burner setting is approached by turning the valve in the closing direction. In order to maximize the heat output at the highest burner setting, the valve preferably has a runoff region where the valve is wide open such that further opening of the valve does not increase the flow of gases through the valve. This region also prevents the backlash movement from rotating the valve past fully open and into a closed region, which may cause the burner to go out when turning to high. Alternatively, in another embodiment it is envisaged that not every desired valve position (corresponding to a burner setting) is approached from the same direction as all the other valve positions. For example, the valve position corresponding to the maximum burner setting may approached from the opposite direction in which the lowest setting is approached from. i.e. the maximum setting may be approached from the direction that opens the valve. In such an embodiment, the runoff region referred to above can be avoided. Similarly, it is anticipated that each of various the valve positions corresponding to each burner setting, may be approached from a different direction than some of the other valve positions. The important aspect is that for any given burner setting, the valve position corresponding to that setting, is always approached from the same side, regardless of whether or not the previous position was lower or higher. As a result, each setting is approached consistently, and therefore the positional accuracy and repeatability is improved. It will be appreciated that the foregoing valve control techniques can be utilized alone or in combination with any one or more of the following described valve control techniques.

In order for the controller to maintain accurate control of the burner setting of each burner, it is necessary for the controller to know the current position of each valve (associated with each burner). It is also necessary that the controller knows how far to move each valve in order to achieve the appropriate fuel gas flow for any desired burner setting. It has been found that individual valves may have different angular positions that result in the same flow due to manufacturing tolerances and inconsistencies. Therefore in order for the controller to achieve accurate control, it is necessary to map each burner setting to a unique valve position for each burner. In particular gas valves typically have a fully closed position which may be associated with a mechanical limit or bump stop. I.e. At the limit of the valves rotation (in one direction) the valve will be fully closed and no fluid (or gas) can pass through. This fully closed position can be used as a convenient reference position.

However, due to manufacturing tolerances and part-to-part variation it is typical for valves of the same type to have different distances between their fully closed position and the position where the valve just begins to open and the minimum flow rate is achieved, or the minimum flow rate that can support a flame is achieved.

Despite the variation in the offset distance between the fully closed position and minimum flow of a typical valve, the distance between the minimum flow position and the highest flow position (fully open) is typically quite uniform for a given gas pressure and jet size. That is to say that once the minimum flow position is reached, the distance to any other given flow position is substantially the same from valve to valve (of the same type/model).

In order to account for these variations, the cook top of the present invention may include a calibration process. Preferably the controller can be switched into a calibration mode through the user interface and back to a normal operating mode when the calibration is complete. Alternatively, a normal operation mode may be restored automatically once calibration is complete. It will be appreciated that each burner of the cook top may need to be calibrated separately.

The burner calibration process finds the distance from the zero position of the burner valve, to the valve position producing the smallest detectable flame setting. In order to detect whether or not a flame is present on the burner, each burner is preferably equipped with a flame detector 107. The flame detection method may be any appropriate method known in the art. For example, flame detection may be achieved electronically by applying an AC current between electrodes positioned at the expected location of a flame. The diode effect of the flame (if present) results in a partially rectified waveform, the presence of which can be used to indicate the presence of a flame. Other known methods such as thermal or optical detection could also be used.

During calibration the controller opens the valve (preferably to a position corresponding to a medium to high burner setting) and ignites the burner. In order to achieve automatic ignition the controller is operationally coupled to an igniter mechanism such as a spark igniter or hot surface igniter or other suitable igniter means. The igniter may be integrated with the flame detector 107). The controller then verifies that ignition was successful and is maintained through flame detection as referred to above. The controller then progressively closes the valve until the flame goes out (as detected by flame detection). The controller records the position of the valve at which the flame was last present. This position is then set as the position corresponding to the lowest burner setting. The result of the gas calibration process is stored in EEPROM. The value is the number of steps from the zero position of the valve to the smallest detectable flame, and is stored as an unsigned integer.

The distance from the fully closed position to the position at which the flame was last detected is recorded as a reference offset. This offset distance corresponds to the portion of the valve movement that may vary significantly from part to part. While the valve position of minimum flow is unlikely to correspond precisely with the burner's lowest setting position, the lowest setting position at which a flame can be detected is a suitable reference from which the valve positions corresponding to all other burner settings can be located.

It is common for a gas valve to include a by-pass port to help achieve a reliable low flow setting. The port may be adjustable via a manual by-pass screw or be fixed. It is envisaged in another embodiment that the low power setting of the burner or cooktop may include fuel gas flow through such a by-pass. The calibration method may still be employed as described above. At the low power setting, some or all of the fuel gas may be supplied via the by-pass.

Alternatively, the calibration method may utilise an adjustable by-pass where the by-pass can be controlled by the controller. In particular; the by-pass can be progressively opened if a low flame cannot be maintained and detected.

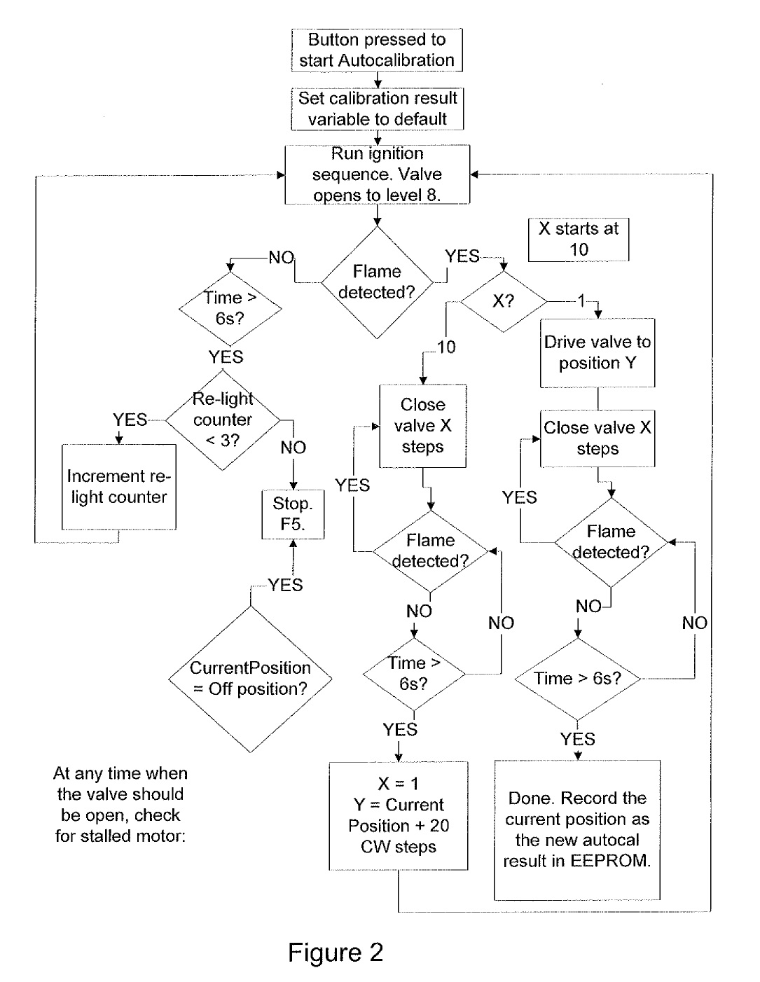

FIG. 2 is a flow chart illustrating the logic of a preferred calibration routine. In particular, to improve efficiency the controller may progressively close the valve quickly at first until the flame goes out. The controller then opens the valve, re-ignites the burner and goes to the last position where a flame was present. It then progressively closes the valve more slowly until the flame goes out. This progressive method allows the controller to more accurately locate the valve position corresponding to the lowest possible burner setting, while not being too slow. It is envisaged that many variations on the calibration process could be implemented including changes to timing, detection of the strength of the flame, averaging multiple calibrations, etc. Each of these corresponds to a further embodiment of the invention.

A calibration fault will occur if either a flame cannot be detected after ignition, or if the controller detects that the valve is not rotating properly and the valve motor is losing synchronization.

Once the reference offset is recorded, a lookup table defines the distance (number of steps) between the lowest setting (from calibration) and each of the burner setting positions. It will be appreciated that the lookup table may contain alternative values to accommodate different fuel gas types, operating pressures, jet sizes, user preferences and different burner types. The number of steps from the fully closed position of the valve to the valve position corresponding to a particular burner setting, is the sum of the reference offset value and all the lookup table values from the lowest burner setting to that particular burner setting.

In order to ensure that the controller can accurately locate the valves fully closed position, it is preferable that a limit switch or bump stop is provided. The sum of all of the look up table values for all burner settings must equal the number of steps required to position the valve corresponding to full power for the burner, without rotating the valve significantly past the point at which maximum flow is achieved. In other words, the full range of burner settings should correspond to valve positions between the lowest detectable flame position and the first position at which the maximum desired flow is achieved.

Alternatively, rather than using the bump stop as a reference, or when no such stop exists, an electrical switch can be used to provide a reference to the off position. The switch may be a mechanical rotary type, or side mounted microswitch with a cam located at an appropriate point on the drivetrain. Alternatively, an optical, or other non-contact device could be used.

Preferably, when the valve is closed the switch should be parked near the center of its closed region, The switch can be used as a safety device to ensure that the controller is aware when a valve is not properly closed. In order to achieve reliable, repeatable positioning of the valve switch, it may be preferable to implement a positional searching algorithm that centers the switch on its cam when the burner is turned off. For example, the valve may be rotated counter-clockwise until completely past the cam, then rotated clockwise until a pre-determined number of steps past the closing point of the switch. Another alternative to a mechanical stop, or an electrical switch, is to use an absolute positional encoder.

Alternatively, valve positions could be calculated via use of one or more formulae. Inputs to such equations may include gas type, pressure, and jet size. While such a formula may be advantageous in terms of memory usage, a series of lookup tables provides an increased degree of configurability with extremely low computation requirements. Each method represents an embodiment of the invention.

The foregoing description of the invention includes preferred forms thereof. Modifications may be made thereto without departing from the scope of the invention as defined by the accompanying claims.

1. A cook top comprising:
a burner,
a valve operated by an actuator to vary the flow of fuel gas from a supply to said burner, wherein said valve is progressively opened by moving in one of a first direction and a second direction, and said valve is progressively closed by moving in the other of said first and said second direction,
a user interface configured to receive a user input indicative of a desired burner setting from a user,
a controller operationally coupled to said actuator and to said user interface, and configured to:
determine a desired position of said valve based on said user input,
cause said actuator to move said valve to said desired position by:
if said desired position is in said first direction from the current position of said valve, moving said valve to said desired position, or
if said desired position is in said second direction from the current position of said valve, moving said valve in said second direction to a position past said desired position and then moving said valve to said desired position.

2. A cook top as claimed in claim 1, wherein the step of moving said valve to said desired position includes a terminal movement immediately prior to said valve arriving at said desired position, and
said terminal movement is always in said first direction.

3. A cook top as claimed in claim 1, wherein when said desired position is in said first direction from the current position of said valve, said step of moving said valve to said desired position includes first moving said valve in said second direction a predetermined amount and then moving said valve in said first direction to said desired position.

4. A cook top as claimed in claim 2, wherein when said desired position is in said first direction from the current position of said valve, said step of moving said valve to said desired position includes first moving said valve in said second direction a predetermined amount and then moving said valve in said first direction to said desired position.

5. A cook top as claimed in claim 1, wherein said first direction closes said valve.

6. A cook top as claimed in claim 1, wherein said first direction opens said valve.

7. A cooktop comprising:
a burner,
a valve operated by an actuator to vary the flow of fuel gas from a supply to said burner,
a user interface configured to receive a user input indicative of a desired burner setting from a user,
a controller operationally coupled to said actuator, and said user interface and configured to:
determine a desired position of said valve based on said user input,
cause said actuator to move said valve from an initial position to said desired position such that said valve arrives, in the terminal portion of movement, at said desired position traveling in the same direction regardless of the direction said desired position is from said initial position.

8. A cook top as claimed in claim 7, wherein said direction of arrival closes said valve.

9. A cook top as claimed in claim 7, wherein said direction of arrival is not the same for every desired position associated with a burner setting.

10. A valve control apparatus comprising:
an actuator coupled to said valve to vary the position of said valve,
said valve being progressively opened by moving in one of a first direction and a second direction, and progressively closed by moving in the other of said first and said second direction,
a controller operationally coupled to said actuator and configured to receive a signal to move said valve, and configured to:
determine a desired position of said valve based on said signal,
cause said actuator to move said valve to said desired position by:
if said desired position is in said first direction from the current position of said valve, moving said valve to said desired position, or
if said desired position is in said second direction from the current position of said valve, moving said valve in said second direction to a position past said desired position and then moving said valve to said desired position.

11. A valve control apparatus as claimed in claim 10, wherein the step of moving said valve to said desired position includes a terminal movement immediately prior to said valve arriving at said desired position, and
said terminal movement is always in said first direction.

12. A valve control apparatus as claimed in claim 10, wherein when said desired position is in said first direction from the current position of said valve, said step of moving said valve to said desired position includes first moving said valve in said second direction a predetermined amount, and then moving said valve in said first direction to said desired position.

13. A valve control apparatus as claimed in claim 11, wherein when said desired position is in said first direction from the current position of said valve, said step of moving said valve to said desired position includes first moving said valve in said second direction a predetermined amount, and then moving said valve in said first direction to said desired position.

14. A valve control apparatus comprising:
an actuator to vary the position of said valve,
a controller operationally coupled to said actuator and configured to receive a signal to move said valve, and configured to:
determine a desired position of said valve based on said signal,
cause said actuator to move said valve from an initial position to said desired position such that said valve arrives, in the terminal portion of movement, at said desired position traveling in the same direction regardless of the direction said desired position is from said initial position.
